(19) United States
(12) Patent Application Publication
(10) Pub. No.: US 2008/0277897 A1
(43) Pub. Date: Nov. 13, 2008

(54) Bicycle front fork structure

(76) Inventor: Sheng-Yuan Lin, Chu Nan Chen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,928

(22) Filed: May 9, 2007

(51) Int. Cl. B62K 19/28; B62K 19/04

(52) U.S. Cl. 280/279

(57) ABSTRACT

The present invention discloses an improved bicycle front fork structure, wherein a reinforcement device is integrated with the inner wall of the joint between the front fork and the vertical tube to enhance the structural strength lest the joint be fractured or distorted. Thereby, the safety of riding a bicycle is promoted.

### BACKGROUND OF THE INVENTION

1. Field of the Invention

The present invention relates to an improved bicycle structure, particularly to an improved bicycle front fork structure.

2. Description of the Related Art

A bicycle is usually made of a metal or carbon fiber. As carbon fiber is lightweight and benefits conveyance, the carbon-fiber bicycle has gradually prevailed. Thus, how to reinforce the structure of a carbon-fiber bicycle and guarantee the safety of the rider has become an important topic. The conventional bicycle front fork structure is like that shown in FIG. 1 no matter whether the front fork is made of a metal or carbon fiber. The upper end of the front fork 10 is connected with a vertical tube 12. Due to the cost factor, the front fork 10 and the vertical tube 12 are generally fabricated separately beforehand and then joined together. However, the joint 14 between the front fork 10 and the vertical tube 12 is apt to fracture, which shortens the lifetime of the bicycle and endangers the rider. Therefore, the present invention proposes an improved bicycle front fork structure to overcome the abovementioned problem and promote the safety of the rider.

### SUMMARY OF THE INVENTION

The primary objective of the present invention is to provide an improved bicycle front fork structure to increase the overall strength of the bicycle structure and promote the safety of a bicycle.

Another objective of the present invention is to provide an improved bicycle front fork structure, which will not fracture even after it has been used for a long time and thus has a long service life.

To achieve the abovementioned objectives, the present invention install a reinforcement device in the joint between a front fork and a vertical tube. Two ends of the reinforcement device are separately integrated with the vertical tube and the front fork. Thereby, the wall of the joint is thickened, and the structure of the joint is reinforced.

Below, the embodiments are described in detail in cooperation with the attached drawings to make easily understood the objectives, technical contents and accomplishments of the present invention.

### BRIEF DESCRIPTION OF THE DRAWINGS

FIG. 1 is a diagram showing a conventional front fork structure;

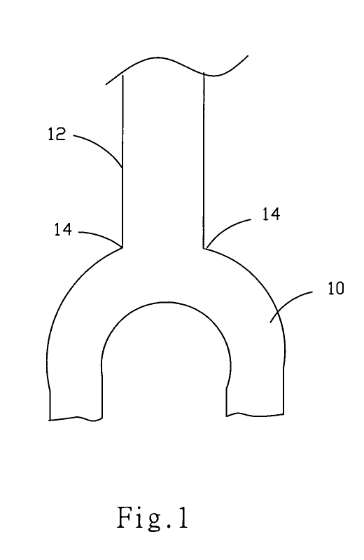

FIG. 2 is a structural perspective view of the front fork structure according to the present invention; and

FIG. 3 is a section view of the front fork structure shown in FIG. 2.

### DETAILED DESCRIPTION OF THE INVENTION

The present invention is to improve the conventional bicycle front fork structure to provide a higher safety front fork structure and solve the conventional problem that the joint of a carbon-fiber front fork and a vertical tube is apt to fracture.

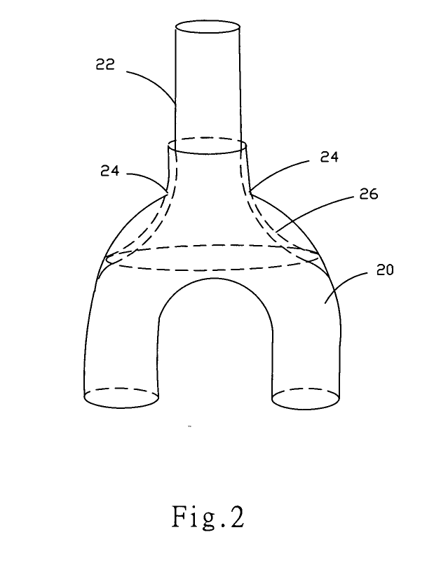

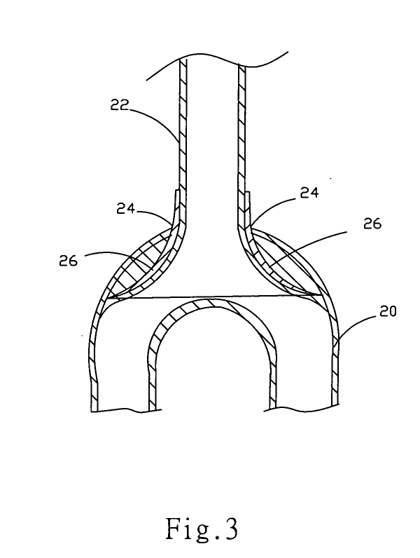

Refer to FIG. 2 and FIG. 3 respectively a structural perspective view and a section view of the front fork structure according to the present invention. The improved front fork structure of the present invention comprises a front fork 20. A vertical tube 22 is joined with the upper end of the front fork 20, and a wheel (not shown in the drawings) is installed in the lower ends of the front fork 20. Both the front fork 20 and the vertical tube 22 are made of carbon fiber. In the fabrication process of the front fork 20 and the vertical tube 22, a reinforcement device 26 is installed in the inner wall of the joint 24 between the front fork 20 and the vertical tube 22. The reinforcement device 26 shown in the drawing has a shape like a trumpet and is made of a metal or carbon fiber. Two ends of the reinforcement device 26 are respectively joined with the vertical tube 22 and the front fork 20. The middle section of the reinforcement device 26 is integrated with the joint 24 to increase the structural strength of the joint 24 lest the front fork structure be fractured by external force. Thus, the conventional problem can be effectively solved.

The fabrication process of the present invention is described below to provide sufficient information to make the persons skilled in the art able to make and use the present invention. The reinforcement device enveloped with a prepreg carbon-fiber material sleeves a core rod, and then the reinforcement device continues to be enveloped with the prepreg carbon-fiber material to form the predetermined structure of the front fork and the vertical tube. The structure is heated and cured. Then, the core rod is withdrawn from the structure, and the structure shown in the drawings is thus obtained.

Those described above are the embodiments to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. An improved bicycle front fork structure comprising a front fork made of carbon fiber and a reinforcement device installed in the inner wall of the joint between said front fork and a vertical tube and used to increase structural strength of said joint.

2. The improved bicycle front fork structure according to claim 1, wherein said reinforcement device is made of carbon fiber.

3. The improved bicycle front fork structure according to claim 1, wherein said reinforcement device is made of a metal.

4. The improved bicycle front fork structure according to claim 1, wherein said reinforcement device has a shape of a ring or a trumpet.
